(19) United States
(12) Patent Application Publication
(10) Pub. No.: US 2015/0176785 A1
(43) Pub. Date: Jun. 25, 2015

(54) LED CANDLE LAMP FOR CHRISTMAS DECORATION

(71) Applicant: MLS Co., Ltd., Zhongshan City (CN)

(72) Inventor: Tianming Liu, Zhongshan City (CN)

(73) Assignee: MLS Co., Ltd., Zhongshan City (CN)

(21) Appl. No.: 14/173,339

(22) Filed: Feb. 5, 2014

(30) Foreign Application Priority Data
Dec. 25, 2013 (CN) 201320870406.6

(51) Int. Cl. F21S 4/00; F21V 31/00; F21K 99/00

(52) U.S. Cl. CPC F21S 4/006; F21K 9/30; F21V 31/00; F21Y 2101/02

(57) ABSTRACT

An LED candle lamp for Christmas decoration, that includes: a lamp holder in a barrel shape provided with a mounting hole; a lamp body in a column shape, with one end mounted in the mounting hole, and the other end extending out of the mounting hole; a flexible LED lamp strip mounted on the end of the lamp body extending out of the mounting hole; a waterproof cover provided with a first cavity, in which the flexible LED lamp strip is located, and an opening of which is hermetically connected with the lamp body; a light-transmittable cover provided with a second cavity, in which the waterproof cover is located, and an entrance of which is hermetically connected with the inside wall of the mounting hole; the gaps at the connections of the light-transmittable cover, the lamp body, the waterproof cover, and the lamp holder are filled with sealant.

### TECHNICAL FIELD

This disclosure relates to an LED candle lamp for a Christmas decoration.

### BACKGROUND

At Christmas time, to enhance the Christmas atmosphere, people decorate both the inside and the outside of their homes, which requires a lot of decorative lamps. With the development of the LED, new decorative lamps may be LED lamps. Since the LED lamps are not only used for indoor decoration, but also used for outdoor decoration, a high waterproof requirement is placed on the lamps. However, the waterproof performance of the existing decorative LED lamps is insufficient. Therefore, an improved design for structure of the existing decorative LED lamps is needed that provides a waterproof structure.

### SUMMARY

To solve the above problem, an LED candle lamp for a Christmas decoration is disclosed.

The disclosed LED candle lamp for a Christmas decoration may include:

a lamp holder which may include a barrel shape and which may be provided with a mounting hole;

a lamp which may include column shape, with one end mounted in the mounting hole, and the other end extending out of the mounting hole;

a flexible LED lamp strip that may be mounted on the end of the lamp body extending out of the mounting hole;

a waterproof cover may be provided with a first cavity, in which the flexible LED lamp strip may be located, and an opening of which may be hermetically connected with the lamp body;

a light-transmittable cover may be provided with a second cavity, in which the waterproof cover may be is located, and an entrance of which may be hermetically connected with the inside wall of the mounting hole;

the gaps at the connections of the light-transmittable cover, the lamp body, the waterproof cover, and the lamp holder may be filled with sealant.

The outside wall of the mounting hole may be provided with an external thread, and the inside wall may be provided with an internal thread.

The ends of the lamp body and the lamp holder may be provided with threads.

The lamp body may be provided with a third cavity, in which a power unit may be mounted.

The side wall of the lamp body may be provided with a through hole in communication with the third cavity.

The lamp body may be made of a high thermal conductivity material.

The light-transmittable cover may assume a candle flame shape.

The benefits of the disclosed LED candle lamp may include that the waterproof cover and the light-transmittable cover may be used to provide a double waterproof effect for the flexible LED lamp strip, so that the waterproof performance of the disclosed LED lamps with the disclosed structure may be significantly increased.

### BRIEF DESCRIPTION OF THE DRAWINGS

The disclosed LED candle lamp will be further illustrated below in connection with the accompanying drawings and the embodiments:

FIG. 1 is a schematic diagram of the disclosed LED candle lamp;

FIG. 2 is a schematic sectional view of the disclosed LED candle lamp;

FIG. 3 is an exploded schematic diagram of the disclosed LED candle lamp.

### DETAILED DESCRIPTION

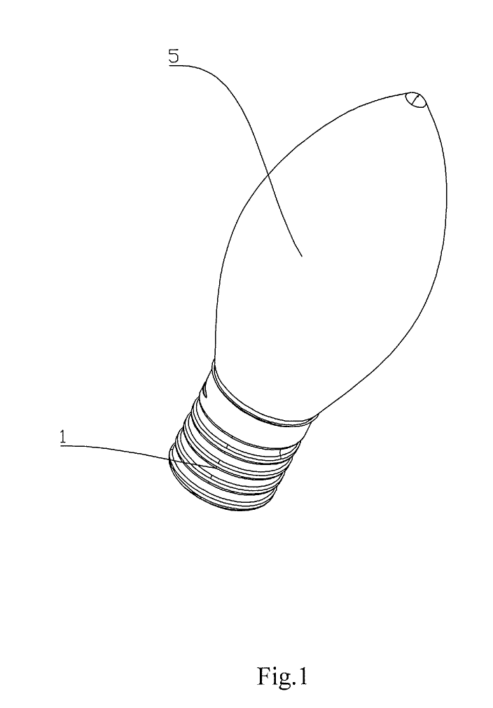

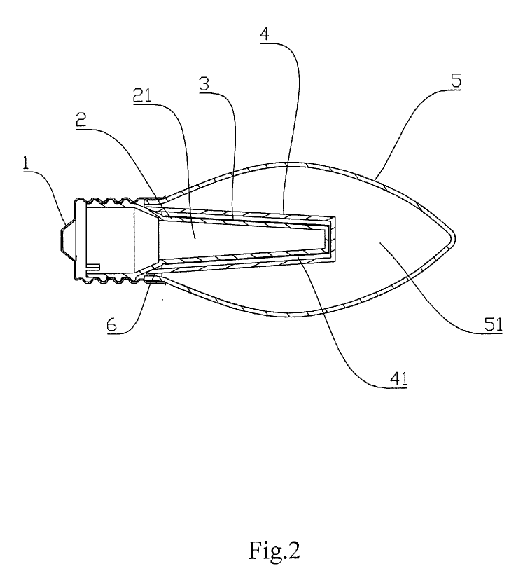

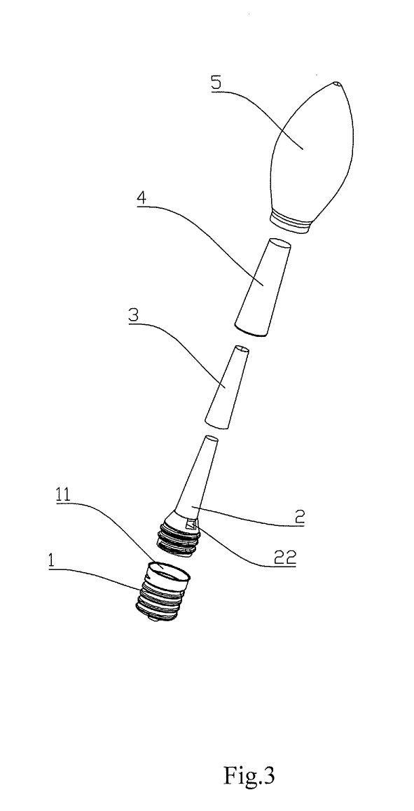

Referring to FIGS. 1 to 3, the present utility model is a disclosed LED candle lamp for Christmas decoration, comprising:

a lamp holder 1 in a barrel shape provided with a mounting hole 11;

a lamp body 2 in a column shape, with one end mounted in the mounting hole 11, and the other end extending out of the mounting hole 11, wherein the lamp body 2 is provided with a third cavity 21, in which a power unit is mounted, and the side wall of the lamp body 2 is provided with a through hole 22 in communication with the third cavity 21 for routing power lines;

a flexible LED lamp strip 3 mounted on the end of the lamp body 2 extending out of the mounting hole 11;

a waterproof cover 4 provided with a first cavity 41, in which the flexible LED lamp strip 3 is located, and an opening of which is hermetically connected with the lamp body 2;

a light-transmittable cover 5 provided with a second cavity 51, in which the waterproof cover 4 is located, and an entrance of which is hermetically connected with the inside wall of the mounting hole 11;

the gaps at the connections of the light-transmittable cover 5, the lamp body 2, the waterproof cover 4, and the lamp holder 1 may be filled with sealant 6. According to the present utility model, the waterproof cover 4 and the light-transmittable cover 5 may be used to provide a double waterproof effect for the flexible LED lamp strip 3, so that the waterproof performance of the disclosed LED candle lamp is significantly increased.

As shown, the outside wall of the mounting hole 11 may be provided with an external thread (for mounting the present utility model), and the inside wall may be provided with an internal thread; the ends of the lamp body 2 and the lamp holder 1 may be provided with threads, and the lamp body 2 and the lamp holder 1 may be connected by those threads.

As shown, to increase the heat dissipation performance of the present utility model, the lamp body 2 may be made of a high thermal conductivity material. Further, different shapes may be selected for the light-transmittable cover 5 according to different operational environments, and in this embodiment, it is preferred that the light-transmittable cover 5 is of a candle flame shape.

The above embodiments are merely the preferred solutions of the present utility model, and other embodiments are also possible. Those skilled in the art may also make equivalent variants or substitutions without departing from the spirit of the present utility model, and these equivalent variants or substitutions are all encompassed within the scope defined by the claims.

1. An LED candle lamp for Christmas decoration, comprising:
a lamp holder having a barrel shape provided with a mounting hole;
a lamp body having a column shape, with one end mounted in the mounting hole, and the other end extending out of the mounting hole;
a flexible LED lamp strip mounted on the end of the lamp body extending out of the mounting hole;
a waterproof cover provided with a first cavity, in which the flexible LED lamp strip is located, and an opening of which is hermetically connected with the lamp body;
a light-transmittable cover provided with a second cavity, in which the waterproof cover is located, and an entrance of which is hermetically connected with the inside wall of the mounting hole;
the gaps at the connections of the light-transmittable cover, the lamp body, the waterproof cover, and the lamp holder are filled with sealant.

2. The LED candle lamp for Christmas decoration according to claim 1, wherein the outside wall of the mounting hole is provided with an external thread, and the inside wall is provided with an internal thread.

3. The LED candle lamp for Christmas decoration according to claim 2, wherein the ends of the lamp body and the lamp holder are provided with threads.

4. The LED candle lamp for Christmas decoration according to claim 1, wherein the lamp body is provided with a third cavity, in which a power unit is mounted.

5. The LED candle lamp for Christmas decoration according to claim 4, wherein the side wall of the lamp body is provided with a through hole in communication with the third cavity.

6. The LED candle lamp for Christmas decoration according to claim 1, wherein the lamp body is made of a high thermal conductivity material.

7. The LED candle lamp for Christmas decoration according to claim 1, wherein the light-transmittable cover assumes a candle flame shape.
